(19) United States
(12) Patent Application Publication
(10) Pub. No.: US 2008/0182093 A1
(43) Pub. Date: Jul. 31, 2008

(54) Multilayer Elastomeric Material Filled With Radiation-Attenuating Compounds, Preparation Method and Uses Thereof

(75) Inventors: Philippe Sonntag, Hericy (FR); Raffi Krikorian, L'Isle Adam (FR); Pierre Hoerner, Maysel (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson

(21) Appl. No.: 12/018,912

(22) Filed: Jan. 24, 2008

(30) Foreign Application Priority Data
Jan. 25, 2007 (FR) 07/00520

(51) Int. Cl. B32B 25/12; B32B 9/00; B32B 27/40; B32B 27/28; B32B 7/02

(52) U.S. Cl. 428/220; 428/411.1; 428/339; 428/336; 428/492; 428/423.1; 428/521; 428/704; 428/335; 428/215

(57) ABSTRACT

The present invention relates to a multilayer elastomeric material having the property of attenuating radiation such as, for example, X-ray and gamma radiation, to its preparation method, and also to its use for manufacturing articles for protection against radiation, in particular X-ray and/or gamma radiation.

### FIELD AND BACKGROUND OF THE INVENTION

The present invention relates to a multilayer elastomeric material having the property of attenuating radiation such as, for example, X-ray and gamma radiation, to its preparation method, and also to its use for manufacturing articles for protection against radiation, in particular X-ray and/or gamma radiation.

In the space of a century, diagnostic radiology, nuclear medicine and radiotherapy have developed considerably to the point of becoming indispensable and incontrovertible tools in all medical specialties. Although the properties inherent to ionizing radiation, especially X-ray and gamma (γ) radiation, have many advantages, the increasingly frequent use of such techniques exposes the general population to increasing doses. This exposure most particularly affects medical staff, whose almost daily exposure to radiation, leads to accumulated doses that are not without danger to their health. This is especially the case in interventional surgery where the medical staff is brought to work in the field of X-ray radiation. Repeated exposure to this radiation, even at a low dose, leads to long-term adverse affects such as dermatitis, or even in certain cases cancers. Medical staff operating directly in the field of X-ray radiation, or using equipment that generates X-rays, therefore require particular protection against this radiation in order to limit or attenuate the doses received.

Devices that aim to protect the sensitive areas of the body or the areas that are highly exposed to this radiation are well known. They include, in particular, aprons, gloves, thyroid shields and gonad shields, comprising a polymer matrix into which radiopaque substances have been incorporated that make it possible to attenuate the radiation.

The radiopaque substances used in the prior art are mainly based on lead in the form of metal, oxides (PbO₂) or salts. For example, such substances have been described in U.S. Pat. No. 3,185,751 and U.S. Pat. No. 3,883,749 for producing, by a dipping process, surgical gloves made of natural latex and polyurethane respectively. The use of a mixture of lead and mercury has also been described, especially in Patent GB 954 593, for producing multilayer materials for protection against ionizing radiation.

According to this Patent GB 954 593, the materials comprise, in particular, a continuous layer composed of an intimate mixture of a lead/mercury amalgam and neoprene, said layer comprising, in addition, a dispersion of mercury droplets. However, the use of lead-based particles is known for accelerating vulcanization phenomena in mixtures formulated from natural latex and therefore it considerably reduces the usage time of these mixtures. Thus, at a relatively high lead content, a natural latex mixture deteriorates too quickly and becomes unusable for manufacturing radio-attenuating gloves according to a dipping-type preparation process. Furthermore, the use of lead more generally poses an environmental problem requiring specific devices for disposal of the waste from the manufacturing process and also for the finished products.

More recently, lead has been replaced in favor of elements whose efficacy in attenuating X-rays is comparable in the energy ranges generally used in interventional surgery (between 60 and 120 kV), such as bismuth and tungsten. For example, in Patent Application US 2004/0262546, the element bismuth is used in the oxide form dispersed in a natural rubber matrix for the production of surgical gloves. Similarly, the use of the element tungsten is described in U.S. Pat. No. 5,215,701 and U.S. Pat. No. 5,548,125 for producing surgical gloves or gloves for medical use that are made of natural rubber or based on an ethylene-propylene diene monomer (EPDM) terpolymer.

The substitution of lead by bismuth or tungsten brings undeniable advantages in terms of stability of the mixtures that are involved in the glove manufacturing processes, but especially in terms of the absence of the recognized toxic effect for the health of people and for the environment.

The efficacy of these elements in attenuating X-rays depends directly on the amount incorporated into the polymer matrix, or more exactly, on the volume fraction of filler in the matrix and on the thickness of this matrix. Thus, the surgical gloves based on bismuth oxide and tungsten oxide described in Patent Application US 2004/0262546 have relatively low levels of X-ray attenuation, since the latter range from between 23% at 100 kV and 58% at 60 kV, i.e. these levels are at most equivalent to a lead thickness of around 0.02 mm. This low efficacy is explained by a relatively low volume fraction of radio-attenuating element(s) in the polymer matrix and by a reduced thickness of the gloves of around 0.3 mm in order not to overly penalize the flexibility and comfort of the glove. Specifically, it is well known that the incorporation of solid particles in the form of fillers into a polymer matrix causes a significant increase in its moduli at low elongation, and consequently leads to a significant loss in terms of flexibility and comfort of the gloves. This is especially the case for the gloves described in U.S. Pat. No. 5,548,125 which are highly filled with tungsten particles (40 vol %), the efficacy of which is certainly much better, greater than 0.1 mm of lead equivalent, but their stiffness and discomfort which result therefrom make them unusable for the practice of surgery.

It emerges from the few examples that, a priori, the efficacy in attenuating X-rays is incompatible with the criteria of comfort and flexibility; a flexible and comfortable glove will not be very effective as it will not be highly filled with radio-attenuating element(s); conversely, an effective glove (>0.1 mm of lead equivalent) will be unusable in interventional surgery due to its stiffness as it is too highly filled.

For these reasons, because they are not effective enough with regard to their cost and/or are too uncomfortable to wear, the protective devices currently on the market, and primarily radioprotective surgical gloves, are not used very much, as they expose the staff working directly in the field or subjected to secondary X-ray beams to risks of serious trauma. In view of the increasingly frequent use of these medical and surgical X-ray techniques, it appears necessary to provide an answer without compromising on the criteria of attenuation efficacy and comfort, which are the only guarantee of a correct final use of the products, and therefore of the protection of the staff in question.

### SUMMARY OF THE INVENTION

The inventors have therefore set themselves the objective of providing a multilayer elastomeric material containing at least one radiopaque substance, especially capable of being used in the medical or paramedical field for manufacturing protective devices that have improved properties as regards the attenuation of X-rays and the flexibility and comfort of said device compound to similar materials from the prior art.

For this purpose, the Applicant has surprisingly discovered that it was possible to incorporate a large amount of radio-attenuating element(s) into an elastomeric film, allowing a high x-ray attenuation to be achieved, which may be greater than or equal to 0.1 mm of lead equivalent, while retaining the initial flexibility of said film when said substance is present within a phase dispersed in the form of liquid droplets within an elastomeric layer. This is because, according to the invention, in order to avoid the inherent stiffening effect on incorporating fillers into an elastomeric material, the radiopaque substance or substances are incorporated into the liquid droplets which are themselves dispersed uniformly in an elastomeric film. The disappearance of the interface between said fillers and the matrix, and also the mobile nature of the liquid dispersed phase, suppresses, for the most part, the stiffening effect of the fillers that is the origin of the poor performance in terms of flexibility and comfort of the existing products.

A first subject of the present invention is therefore a multilayer elastomeric material comprising at least two outer layers L1 and L3 trapping at least one intermediate layer L2, said intermediate layer being formed by an elastomeric matrix comprising at least one dispersion of droplets of at least one composition containing at least one radiopaque substance, wherein the volume fraction φᵥ of the radiopaque substance or substances within the layer L2 is greater than or equal to 20% and wherein said composition is liquid or gelled and said radiopaque substance is in the form of solid particles.

In the material according to the present invention, the disappearance of the interface between said fillers and the matrix, and also the mobile nature of the liquid dispersed phase, suppresses, for the most part, the stiffening effect of the fillers that is the origin of the poor performance in terms of flexibility and comfort of the existing products. Thus, thanks to its particular composition, said material has an elastic modulus at 100% elongation (M100) between 0.2 and 1 MPa. According to one preferred embodiment of the invention, this modulus is between 0.2 and 0.7 MPa.

According to the invention, the term “radiopaque substance” is understood to mean any substance having a protective effect with regard, in particular, to exposure to X-rays, ionizing radiation such as gamma and beta rays or to radiation used in radiotherapy, especially for the treatment of cancers and any other radiation having a harmful effect on the health of an organism which is exposed thereto (radiation due to the use of nuclear weapons, for example). Also within the meaning of the present invention, the expression “protective effect” is understood to mean any decrease or suppression of the harmful effects caused by said radiation by decreasing the amount of radiation transmitted in the energy range in question.

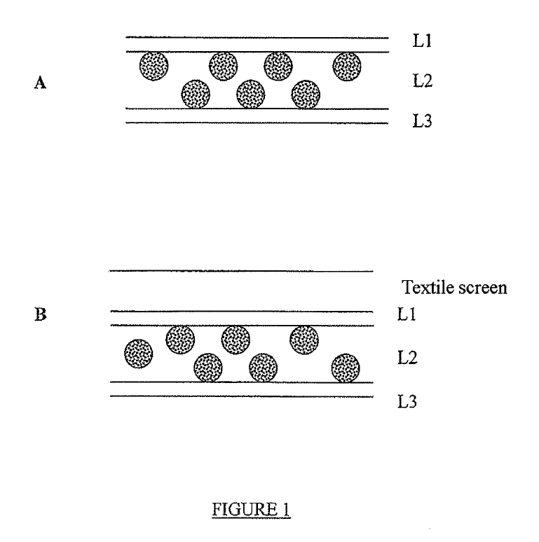

The material according to the invention may be represented according to the scheme from the appended FIG. 1A in which the layers L1 and L3 are outer layers and L2 represents the intermediate layer containing the radiopaque substance or substances dispersed in the form of droplets of a liquid composition.

In the material according to the present invention, the liquid containing the radiopaque substance or substances is dispersed in a uniform and stable manner in the form of droplets and thus makes it possible to offer a homogeneous attenuation of the radiation over the entire surface of the film.

According to this invention, the efficacy of the multilayer material in attenuating the radiation mainly depends on the characteristics of the layer L2, namely on the droplet packing ratio, on the fraction of droplets introduced into the matrix of the layer L2 and on the thickness of the layer L2. The mechanical properties (tensile strength, elastic constant) of the material taken in its entirety mainly depend on the intrinsic properties of the layers L1 and L3, namely their mechanical properties (tensile strength and elastic constant) and dimensional properties (thickness).

The material according to the invention preferably has an ability for attenuating radiation, expressed as lead equivalent, greater than 0.02 mm.

According to the invention, the elastomeric material preferably has a total thickness between 300 μm and 3000 μm inclusive.

The thickness of each of the layers L1, L2 and L3 of said material, which are identical or different, preferably varies from 50 to 2500 μm.

According to one preferred embodiment of the invention, the average diameter of the droplets of the composition containing the radiopaque substance or substances is between 1 and 100 μm inclusive, and even more preferably between 1 and 10 μm inclusive.

According to the invention, the elastomer or elastomers constituting the outer layers L1 and L3 and also the intermediate layer L2 are preferably chosen from natural rubber, polybutadiene, polyisoprene, polychloroprene, polyurethane, acrylic polymers or copolymers, silicone elastomers, the copolymers: SBR (styrene-butadiene rubber), SBS (styrene-butadiene-styrene), isobutene/isoprene such as butyl rubber, NBR (nitrile-butadiene rubber), xNBR (carboxylated nitrile-butadiene rubber), SIS (styrene-isoprene-styrene), SEBS (styrene-ethylene/butylene-styrene) and blends thereof, it being understood that the nature of the elastomer or elastomers constituting each of said layers may be identical or different from one layer to the next.

The properties of the elastomers (molar mass, chemical and/or physical crosslink density) are of course chosen as a function of the final properties desired for the material taken in its entirety which must meet the constraints mentioned above. Thus, according to one preferred embodiment of the invention, said elastomer or elastomers are chosen from SIS and SEBS.

In addition to the elastomers defined above, at least one of the barrier layers L1 and L3, and/or the intermediate layer L2, may moreover additionally contain one or more plasticizers or flexibilizers the chemical nature and the content of which are compatible with the previously defined properties of the material.

When they are used, these plasticizers are preferably chosen from mineral oils, among which mention may especially be made of paraffin oils, naphthenic or aromatic oils and mixtures of these products.

When they are used, the plasticizer or plasticizers preferably represent from 5 to 500 parts per 100 parts of elastomer forming the layer within which they are present.

It should be noted that the chemical nature, composition or thickness of the layer L1 is not necessarily equivalent to that of the layer L3.

Finally, each layer L1 or L3 may, as a variant, result from the superposition of two or more layers of equivalent or nonequivalent chemical nature. In this case, the intrinsic properties of each of the layers L1 and L3 will then be those measured on each complete layer.

The intermediate layer L2 serves as a matrix for the droplets of the composition containing the radiopaque substance or substances used.

According to the invention, the nature of this radiopaque substance could be chosen as a function of the characteristics of the radiation (X-ray, gamma, beta, energy) that it is desired to attenuate. These substances will preferably be chosen from chemical elements having a high atomic number, even more particularly from elements having an atomic number greater than or equal to 40, while avoiding toxic elements such as lead or mercury. Thus, according to one preferred embodiment of the invention, said material is free of lead and mercury. Among these elements, mention may especially be made of bismuth, tungsten, barium, iodine, tin and mixtures thereof, said elements being in the form of metal particles, in oxide form or in salt form. The size of the particles of the radiopaque substance is preferably between 0.5 and 50 μm inclusive, and even more preferably between 0.5 and 5 μm inclusive.

In addition to the radiopaque substance or substances, the composition in the form of droplets contains, in addition, one or more diluents. These diluents make it possible to improve the dispersion of said radiopaque substance or substances.

This diluent may be chosen from polyols and preferably from glycerol, ethylene glycol and polyethylene glycols that are liquid at ambient temperature or at a temperature close to ambient temperature (between around 20 and 30° C.) and have a molar mass between 62 (ethylene glycol) and 750 Da inclusive (polyethylene glycol: PEG 750) and mixtures thereof, and also from any other compound compatible with the radiopaque substance or substances used.

Moreover, the composition in the form of droplets containing the radiopaque substance or substances may also contain one or more additives that make it possible to adjust the final properties of the mixture such as surfactants, dispersants or thickeners.

The composition in the form of droplets containing the radiopaque substance or substances may be in liquid form (in the form of an emulsion) or gelled form. When it is in gelled form, said composition then contains at least one gelling agent, preferably chosen from gelatin and semicrystalline polyethylene oxides. The fact of gelling this composition makes it possible to fix the particles of the radiopaque substance or substances inside the droplets and to prevent them from coming out of the droplets due to their very high relative density.

According to one particular embodiment of the invention, the intermediate layer L2 may be formed from a superposition of two or more intermediate sublayers each comprising a dispersion of droplets, the nature of the radiopaque substances contained in each of said sublayers being identical or different from one sublayer to another. In this case, the intrinsic properties of the layer L2 will then be those measured on the complete layer.

According to another particular embodiment of the invention, the intermediate layer L2 is formed by a single layer containing a dispersion of droplets that consist of radiopaque substances that are different from one droplet to another.

According to another particular embodiment of the invention, and in order to improve the properties of the material with respect to the attenuation of radiation, the radiopaque substance or substances may be dispersed, in addition to the droplets, directly in the matrix of the layer L2, provided that, of course, the properties of the material taken in its entirety remain in accordance with the invention.

Each of the layers forming the multilayer elastomeric material according to the invention may contain, moreover, other adjuvants conventionally used in the polymer industry such as, for example, antistatic agents, lubricants, antioxidants, dyes, processing aids or else adhesion promoters depending on the particular properties that it is desired to give it so long as, of course, its adjuvants are compatible together and with the intrinsic properties of said material such as defined previously.

According to one variant of the invention, the multilayer elastomeric material may be reinforced by an elastic textile screen of natural or synthetic organic fibers thus serving as a support for one of the two or both layers L1 and L3. When the textile screen is only adjacent to the layer L1, this type of multilayer material may be represented by the diagram of appended FIG. 1B in which the layers L1 and L3 are the outer layers and L2 represents the intermediate layer containing the radiopaque substance or substances dispersed in the form of droplets of a liquid composition, said layer L1 being surmounted by a textile screen.

The bond between the various constituent layers of the material according to the invention may, optionally, be provided by a bonding agent or by a chemical or physicochemical modification of any one of the layers. Such a treatment does not however have an influence on the final properties of the material.

According to the invention, the expression “chemical modification” is understood to mean either grafting, or a chemical attack, and the expression “physicochemical modification” is understood to mean a bombardment of the surface of the film with ions, electrons or photons.

Owing to the presence of the radiopaque substance or substances, the multilayer elastomeric material according to the invention may be used for manufacturing elastomeric articles for protection against radiation, in particular against X-rays, ionizing rays such as gamma and beta rays, and also against the radiation used in radiotherapy, especially anticancer radiotherapy. According to one preferred embodiment of the invention, said material is used for manufacturing elastomeric articles for protection against X-rays and/or gamma rays.

Although any form of presentation may be envisaged, these articles are generally in the form of aprons, gloves, finger stalls, thyroid shields or gonad shields.

The manufacture of the multilayer material such as defined above may be carried out according to a process of coating onto a textile support for example, or else according to a process of successive dipping and evaporation of a form corresponding to the envisaged use, in organic solutions or aqueous dispersions (latex) of the elastomer or elastomers chosen in order to successively form the layers L1, L2 and L3, the formation of the layer L2 being, for example, carried out according to one of the following processes consisting:
either in preparing a stable emulsion formed by droplets of a liquid composition containing the radiopaque substance or substances in a solution of elastomer in a volatile solvent by analogy with what is described, in particular, in Patent EP 0 981 573 B1;
or in preparing a dispersion of said droplets in gelled form, or crystallized form (microspheres) in a solution of the elastomer in a volatile solvent by analogy with what is described in Patent EP 0 771 837 B1;
or in depositing the droplets, for example in the form of microspheres or microcapsules, on the layer L1 and/or L3, then in covering said droplets with an elastomer, either in the form of a solution of the latter in an organic solvent, or in the form of an aqueous dispersion (latex), or in solid form.

During this process, each dipping operation is followed by a period of evaporation, generally in a thermostatted oven, during which the solvent or water is eliminated.

Besides the preceding arrangements, the invention also comprises other arrangements which will emerge from the description that follows, which refers to the examples of preparing the radiopaque intermediate layer L2 and to an example of preparing usable multilayer elastomeric materials according to the invention that are in the form of gloves for protection against X-rays and also to the appended FIG. 1 in which:

FIG. 1A represents a material according to the invention composed of two outer layers L1 and L3 and of an intermediate layer L2 containing the radiopaque substance or substances dispersed in the form of droplets of a liquid composition; and
FIG. 1B represents a material according to the invention and such as represented in FIG. 1A, but in which the layer L1 is, in addition, surmounted by a textile screen.

### EXAMPLE 1

### Preparation of an Elastomer Bath for Producing a Radiopaque Intermediate Layer L2

An elastomer bath B1 that could be used for producing a radiopaque intermediate layer L2 was prepared, said bath having the following composition:

| | |
|---|---|
| SEBS copolymer sold under the trade name | 41.0 g |
| KRATON ® G1652 by Kraton Polymers | |
| White mineral oil sold under the trade name | 29.0 g |
| PRIMOL ® 352 by Esso (plasticizer) | |
| Cyclohexane (Total) | 200.0 g |
| Radiopaque substance: bismuth trioxide (Bi₂O₃) | 318.0 g |
| Diluent for the dispersed phase of the | 79.0 g |
| emulsion: polyethylene glycol (PEG 200) | |

The continuous phase of the emulsion was composed of around 13 wt % of a mixture of the KRATON® G1652 copolymer and the PRIMOL® 352 mineral oil used as a plasticizer. Within this mixture, the elastomer/plasticizer weight proportions were 100/70. The plasticized elastomer was left in contact with the solvent (cyclohexane) for 1 hour and 30 minutes in order to allow the copolymer/plasticizer mixture to dissolve.

This continuous phase contained a dispersed phase of droplets of radiopaque substance formed of Bi₂O₃ and of PEG 200 in weight proportions of 80/20. The dispersed phase was homogenized using a deflocculator for 10 minutes at 2500 rpm.

The dispersion of the radiopaque phase in the continuous phase was carried out using an Ultra-Turrax disperser/homogenizer for 10 minutes at a rate of 15 000 rpm or using a deflocculator for 20 minutes at 2500 rpm.

### EXAMPLE 2

### Preparation of an Elastomer Bath for Producing a Radiopaque Intermediate Layer L2

An elastomer bath B2 that could be used for producing a radiopaque intermediate layer L2 was prepared, said bath having the following composition:

| | |
|---|---|
| KRATON ® G1652 | 28.0 g |
| PRIMOL ® 352 | 29.0 g |
| Cyclohexane | 224.0 g |
| o-Xylene | 28.0 g |
| Bi₂O₃ | 256.0 g |
| Diluent for the dispersed phase of the | 64.0 g |
| emulsion: gelatin/water/PEG 200 | |

The continuous phase of the emulsion was composed of around 10 wt % of a mixture of the KRATON® G1652 copolymer and the PRIMOL® 352 mineral oil used as a plasticizer. Within this mixture, the elastomer/plasticizer weight proportions were 100/100. The plasticized elastomer was left in contact with the solvent for 1 hour and 30 minutes in order to allow the copolymer/plasticizer mixture to dissolve. The solvent was composed of a mixture of cyclohexane (Total) and ortho-xylene (Total) in weight proportions of 88/12.

This continuous phase contained a dispersed phase of droplets of radiopaque substance formed of Bi₂O₃ in solution in a mixture composed of gelatin, water and PEG 200, in weight proportions of 80/20. This phase was homogenized using a deflocculator for 10 minutes at 2500 rpm.

The gelatin/water/PEG 200 mixture was prepared previously by dissolving the constituents for 2 hours in an oven at 60° C., in the respective weight proportions of 4/86/10.

The dispersion of the radiopaque phase in the continuous phase was carried out using an Ultra-Turrax disperser/homogenizer for 10 minutes at a rate of 15 000 rpm or using a deflocculator for 20 minutes at 2500 rpm.

### EXAMPLE 3

### Preparation of an Elastomer Bath for Producing a Radiopaque Intermediate Layer Containing Bismuth Trioxide in Both Phases of the Emulsion

An elastomer bath B3 that could be used for producing a radiopaque intermediate layer L2 was prepared, said bath having the following composition:

| | |
|---|---|
| KRATON ® G1652 | 40.0 g |
| PRIMOL ® 352 | 28.0 g |
| Cyclohexane | 210.0 g |
| Bi₂O₃ | 724.0 g |
| Diluent for the dispersed phase of the | 72.0 g |
| emulsion: PEG 200 | |

The continuous phase of the emulsion was composed of a mixture (around 8 wt % relative to the solids content) of the KRATON® G1652 copolymer and the PRIMOL® 352 mineral oil used as a plasticizer. Within this mixture, the elastomer/plasticizer weight proportions were 100/70. The plasticized elastomer was left in contact with the solvent for 1 hour and 30 minutes in order to allow the copolymer/plasticizer mixture to dissolve. The solvent used was cyclohexane (Total). Around 450 g (i.e. 45 wt % relative to the solids content) of Bi₂O₃ were added to the continuous phase of the emulsion. This phase was homogenized using an Ultra-Turrax disperser/homogenizer for 5 minutes at a rate of 15 000 rpm.

This continuous phase contained a dispersed phase of droplets of radiopaque substance made up of Bi₂O₃ in solution in PEG 200 and in weight proportions of 80/20. This phase was homogenized using a deflocculator for 10 minutes at 2500 rpm.

The dispersion of the radiopaque phase in the continuous phase was carried out using an Ultra-Turrax disperser/homogenizer for 10 minutes at a rate of 15 000 rpm or using a deflocculator for 20 minutes at 2500 rpm.

### EXAMPLE 4

### Preparation of Multilayer Materials Incorporating a Radiopaque Intermediate Layer L2

This example describes the preparation of a multilayer elastomeric material in the form of a glove, said material being produced from a synthetic elastomer in a solvent medium.

A first bath of elastomer in a solvent (cyclohexane) composed of 20 wt % (relative to the solids content) of a mixture of SEBS copolymer sold under the trade name KRATON® G1652 by Kraton Polymers and of a mineral oil (PRIMOL® 352, Esso) used as a plasticizer, was prepared. Within this mixture, the elastomer/plasticizer weight proportions were 100/30. This bath was used to produce the barrier layers L1 and L3.

Furthermore, and according to each of the processes described in Examples 1 to 3, three elastomer baths were prepared containing a dispersion of droplets of radiopaque substance (baths B1, B2 and B3 corresponding respectively to Examples 1, 2 and 3 explained in detail previously).

The multilayer elastomeric material was then prepared by successive dipping operations of a porcelain mold having the shape of a hand in the following manner:
1) formation of the barrier layer L1: two successive dipping operations in the first elastomer bath;
2) formation of the intermediate layer L2: two successive dipping operations in the second elastomer bath (baths B1, B2 or B3) containing the dispersion of the radiopaque substance; then
3) formation of the barrier layer L3: two successive dipping operations in the first elastomer bath, it being understood that each dipping step was immediately followed by a solvent evaporation step, first in open air, then in an oven at 40° C., until the solvent had completely evaporated.

The properties of the materials M1, M2 and M3 thus obtained respectively by carrying out a dipping step in the elastomer baths B1, B2 and B3 containing the dispersion of the radiopaque substance to form an intermediate layer L2 are given in Tables I to III below:

TABLE I
(material M1/bath B1)

| | M100 | Volume fraction of | | | | |
|---|---|---|---|---|---|---|
| | modulus | Bi₂O₃ in the layer | Attenuation | | | |
| Thickness (mm) | (MPa) | L2 (%) | 60 kV | 80 kV | 100 kV | 120 kV |
| 0.4 | 0.35 | 20 | 52% | 48% | 45% | 37% |

TABLE II
(material M2/bath B2)

| | M100 | Volume fraction of | | | | |
|---|---|---|---|---|---|---|
| | modulus | Bi₂O₃ in the layer | Attenuation | | | |
| Thickness (mm) | (MPa) | L2 (%) | 60 kV | 80 kV | 100 kV | 120 kV |
| 0.5 | 0.40 | 20 | 63% | 57% | 52% | 46% |

TABLE III
(material M3/bath B3)

| | M100 | Volume fraction of | | | | |
|---|---|---|---|---|---|---|
| | modulus | Bi₂O₃ in the layer | Attenuation | | | |
| Thickness (mm) | (MPa) | L2 (%) | 60 kV | 80 kV | 100 kV | 120 kV |
| 0.48 | 0.34 | 36 | 78% | 70% | 64% | 60% |

Since these materials are in the form of gloves they can then be used directly for protecting the hands against X-rays.

1. A multilayer elastomeric material comprising at least two outer layers L1 and L3 trapping at least one intermediate layer L2, said intermediate layer being formed by an elastomeric matrix comprising at least one dispersion of droplets of at least one composition containing at least one radiopaque substance, wherein the volume fraction φv of the radiopaque substance or substances within the layer L2 is greater than or equal to 20% and wherein said composition is liquid or gelled and said radiopaque substance is in the form of solid particles.

2. The material as claimed in claim 1, which has a total thickness between 300 μm and 3000 μm inclusive.

3. The material as claimed in claim 1, wherein the thickness of each of the layers L1, L2 and L3, which are identical or different, varies from 50 to 2500 μm.

4. The material as claimed in claim 1, wherein the average diameter of the droplets of the composition containing the radiopaque substance or substances is between 1 and 100 μm inclusive.

5. The material as claimed in claim 4, wherein the average diameter of the droplets of the composition containing the radiopaque substance or substances is between 1 and 10 μm inclusive.

6. The material as claimed in claim 1, wherein the elastomer or elastomers constituting the outer layers L1 and L3 and also the intermediate layer L2 are preferably chosen from natural rubber, polybutadiene, polyisoprene, polychloroprene, polyurethane, acrylic polymers or copolymers, silicone elastomers, the copolymers: SBR (styrene-butadiene rubber), SBS (styrene-butadiene-styrene), isobutene/isoprene such as butyl rubber, NBR (nitrile-butadiene rubber), x-NBR (carboxylated nitrile-butadiene rubber), SIS (styrene-isoprene-styrene), SEBS (styrene-ethylene/butylene-styrene) and blends thereof, it being understood that the nature of the elastomer or elastomers constituting each of said layers may be identical or different from one layer to the next.

7. The material as claimed in claim 6, wherein said elastomers are chosen from SIS (styrene-isoprene-styrene) and SEBS (styrene-ethylene-butylene-styrene).

8. The material as claimed in claim 1, wherein at least one of the barrier layers L1 and L3, and/or the intermediate layer L2 contain, in addition, one or more plasticizers or flexibilizers.

9. The material as claimed in claim 8, wherein the plasticizer or plasticizers represent from 5 to 500 parts per 100 parts of elastomer forming the layer within which they are present.

10. The material as claimed in claim 1, wherein each layer L1 or L3 results from the superposition of two or more sublayers of equivalent or non-equivalent chemical nature.

11. The material as claimed in claim 1, wherein the radiopaque substance or substances are chosen from the elements having an atomic number of greater than or equal to 40.

12. The material as claimed in claim 11, wherein the elements are chosen from bismuth, tungsten, barium, iodine, tin and mixtures thereof, said elements being in the form of metal particles, in oxide form or in salt form.

13. The material as claimed in claim 12, wherein the size of the particles of the radiopaque substance or substances is between 0.5 and 50 μm inclusive.

14. The material as claimed in claim 13, wherein the size of the particles of the radiopaque substance or substances is between 0.5 and 5 μm inclusive.

15. The material as claimed in claim 1, wherein the composition in the form of droplets contains, in addition, one or more diluents.

16. The material as claimed in claim 15, wherein the diluent is chosen from glycerol, ethylene glycol and polyethylene glycols that are liquid at ambient temperature or at a temperature close to ambient temperature and have a molar mass between 62 and 750 Da inclusive.

17. The material as claimed in claim 1, wherein the composition in the form of droplets containing the radiopaque substance or substances is in gelled form and contains at least one gelling agent chosen from gelatin and semi-crystalline polyethylene oxides.

18. The material as claimed in claim 1, wherein the intermediate layer L2 is formed from a superposition of two or more intermediate sublayers each comprising a dispersion of droplets, the nature of the radiopaque substances contained in each of said sublayers being identical or different from one sublayer to another.

19. The material as claimed in claim 1, wherein the intermediate layer L2 is formed by a single layer containing a dispersion of droplets that consist of radiopaque substances that are different from one droplet to another.

20. The material as claimed in claim 1, wherein the radiopaque substance or substances may, in addition, be directly dispersed, in addition to the droplets, in the matrix of the layer L2.

21. The material as claimed in claim 1, which is reinforced by an elastic textile screen of natural or synthetic organic fibers serving as a support for one of the two or both layers L1 and L3.

22. The material as claimed in claim 1, which is in the form of aprons, gloves, fingerstalls, thyroid shields or gonad shields.

23. A method for manufacturing elastomeric articles for protection against radiation comprising fabricating an elastomeric article from at least one multilayer elastomeric material as defined in claim 1.

24. The method as claimed in claim 23, against X-rays, ionizing rays and radiation used in radiotherapy.

25. The method as claimed in claim 23, against X-rays and/or gamma rays.

26. The method as claimed in claim 23, wherein the fabricating step comprises fabricating an article selected from the group consisting of aprons, gloves, finger stalls, thyroid shields and gonad shields.
